(19) United States
(12) Patent Application Publication
(10) Pub. No.: US 2009/0009258 A1
(43) Pub. Date: Jan. 8, 2009

(54) Enhanced Spectral Keying for Wireless Ultra Wideband Communications

(76) Inventor: Pen Chung Li, San Jose, CA (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(21) Appl. No.: 10/588,130

(22) PCT Filed: Jan. 27, 2005
(86) PCT No.: PCT/IB05/50371

§ 371 Date: Sep. 20, 2008

Related U.S. Application Data
(60) Provisional application No. 60/540,378, filed on Jan. 29, 2004.

(51) Int. Cl. H04B 1/69; H04L 27/30

(52) U.S. Cl. 332/103

(57) ABSTRACT

Methods provide for the amount of information encoded by spectral keying into a UWB symbol having a plurality of modulation symbol times, to be increased by operating two or more frequency band carriers simultaneously during at least one of a plurality of modulation symbol times. In one aspect of the present invention, once a frequency resource, such as a carrier, has been used during a given modulation symbol time, those frequency resources are not used again within that UWB symbol. A method of transmitting symbols, includes providing (302) data to be transmitted, determining (304), which frequency carriers, if any, of a set of n frequency carriers, are to be turned on during each of n modulation symbol times, and turning on (306) each of the determined frequency carriers during each of the modulation symbol times, and wherein each frequency carrier is turned on only once during the transmission of the symbol.

The present invention relates generally to wireless communication, and more particularly relates to spectral keying in ultra wideband communications.

Ultra wideband (UWB) communications are a form of radio communication in which a signal is spread over a large portion of the radio spectrum, and in which the signal power at any particular frequency is therefore relatively small. The bandwidth of such systems is typically greater than 500 MHz, and in some UWB systems the bandwidth may be, for example, between 2 GHz and 100 GHz. Early UWB systems imparted information to their signals through the use of pulse position modulation. Such pulse position modulation is sometimes referred to in the context of UWB systems as time modulation.

By slightly changing the pulse position, that is, the time at which a pulse occurs, information can be encoded into, and subsequently derived from, a UWB signal. For example, a slightly early pulse may be interpreted as a “zero”, while a slightly delayed pulse may be interpreted as a “one”. Unfortunately, this only provides one bit of information per transmitted pulse.

What is needed are methods and apparatus for increasing the information content of ultra wideband signalling schemes.

Briefly, the amount of information encoded by spectral keying into a UWB symbol having a plurality of modulation symbol times, is increased by operating two or more frequency band carriers simultaneously during at least one of a plurality of modulation symbol times. In one aspect of the present invention, once a frequency resource, such as a carrier, has been used during a given modulation symbol time, those frequency resources are not used again within that UWB symbol.

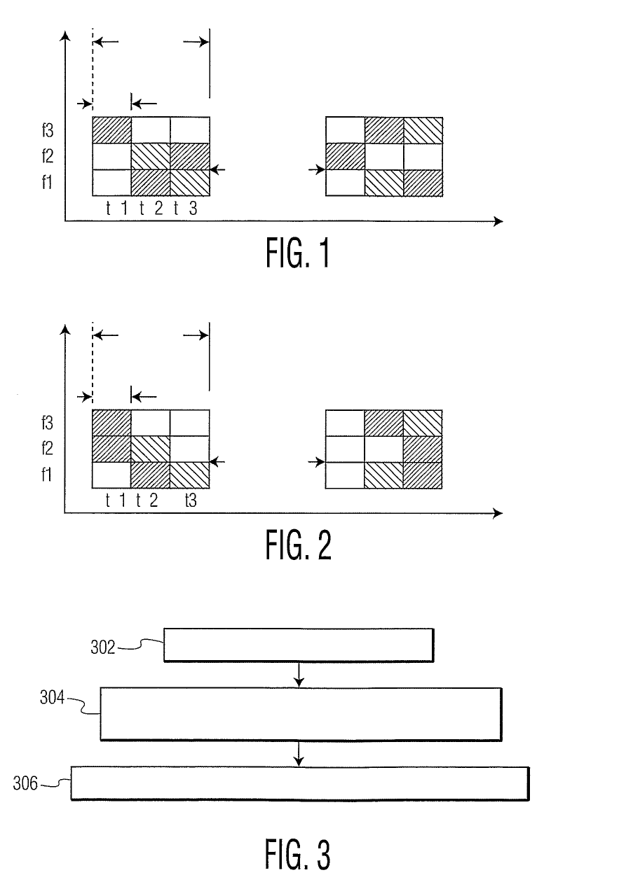

FIG. 1 is a frequency versus time diagram illustrating one scheme for transmission of symbols in a known ultra wideband communication system.

FIG. 2 is a frequency versus time diagram illustrating a scheme for transmission of symbols in an ultra wideband communication system in accordance with the present invention.

FIG. 3 is a flow diagram illustrating a method in accordance with the present invention.

Generally, the present invention relates to methods and apparatus for increasing the information content of ultra wideband signalling schemes. More particularly, the present invention relates to spectral keying in an ultra wideband communication system wherein more than one carrier can be turned on at any given time.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment Furthermore, various particular features, structures, operations, or characteristics may be combined in any suitable manner in one or more embodiments.

Embodiments of the present invention provide advantages with respect to previous spectral keying schemes by allowing more than one carrier to be turned on at any given time. Such previous spectral keying schemes use permutations of available carriers to represent UWB symbols. Embodiments of the present invention take advantage of combinations of carrier frequencies, in addition to permutations, thereby allowing more information bits to be packed within the same bandwidth, UWB symbols can be represented by the same number of “on” carriers, except that embodiments of the present invention allow multiple carriers to be “on” at the same time.

Referring to FIG. 1, a frequency versus time diagram illustrating one scheme for transmission of symbols in a known ultra wideband communication system is shown. More particularly, FIG. 1 illustrates an example in which two UWB symbols are transmitted, the UWB symbols each having three frequency bands and three modulation symbols. This is referred to generally as spectral keying. It can be seen in FIG. 1 that each UWB symbol is made up of three modulation symbol times (i.e., t1, t2, and t3); and that the UWB symbols are separated from each other by a guard time. In this illustrative example, only one carrier (i.e., f1, f2 or f3) can be turned on to transmit a modulation symbol. Once a carrier has be turned on, it cannot be turned on again in that UWB symbol. As illustrated in FIG. 1, the first UWB symbol consists of frequency band f3 at time t1, frequency band f1 at time t2, and frequency band f2 at time t3. This can be expressed in a convenient notation as f3@t1, f1@t2, and f2@t3. A further notational simplification is to express the three modulation symbol times as {3,1,2}, where it is understood that the numbers of the triplet represent which one of the three carriers is turned on respectively at times t1, t2, and t3. Still referring to FIG. 1, the second UWB symbol shown consists of frequency band f2 at time t1, frequency band f3 at time t2, and frequency band f1 at time t3. In accordance with the simplified notation described above, the second UWB symbol may be represented as {2,3,1}.

In order to calculate the number of bits packed into one UWB symbol as illustrated in FIG. 1, assume BPSK is used for modulation. It can be shown that there are three bits as the result of BPSK modulation, while there are log₂(3!)=2.58 bits as the result of permutation. Therefore the total number of information bits is 5.58. As can be seen from the foregoing, spectral keying as illustrated in FIG. 1 gives an additional log₂(n!) bits assuming that the number of frequency carriers is equal to the number of modulation symbols in the UWB symbol, and that number is represented by n.

Referring to FIG. 2, a frequency versus time diagram illustrating a scheme for transmission of UWB symbols in accordance with the present invention is shown. More particularly, FIG. 2 illustrates an example in which two UWB symbols are transmitted, the UWB symbols each having three frequency bands and three modulation symbols. This is referred to generally as enhanced spectral keying. It can be seen in FIG. 2 that each UWB symbol is made up of three modulation symbol times (i.e., t1, t2, and t3); and that the UWB symbols are separated from each other by a guard time. In this illustrative example of the present invention, more than one carrier (i.e., f1, f2 or f3) can be turned on to transmit a modulation symbol. In this embodiment of the present invention, once a carrier has be turned on in a given UWB symbol, it cannot be turned on again in that UWB symbol. As illustrated in FIG. 2, the first UWB symbol consists of frequency band f2 and frequency band f3 at time t1; frequency band f1 at time t2; and none of the frequency band carriers are turned on at time t3. This can be expressed in a convenient notation as {(2,3),1,0}, where it is understood that the numbers of this notation represent which one, or ones, of the three carriers are turned on respectively at times t1, t2, and t3, and where 0 represents that all the frequency band carriers are in an “off” state. Still referring to FIG. 2, the second UWB symbol shown consists of no frequency band carriers being turned on at time t1; frequency band f3 at time t2; and frequency band f1 and frequency band f2 at time t3. In accordance with the simplified notation described above, the second UWB symbol may be represented as {0,3,(1,2)}.

It is noted that although the enhanced spectral keying of the present invention contemplates a modulation symbol time within the UWB symbol time in which no frequency carrier is turned on, no modulation information is lost as a result because there are still three “on” carriers in each UWB symbol. It is noted that carriers f1, f2, and f3, may transmit at frequency bands that are contiguous with each other, or they may be separated from each other by any arbitrary amount. It is further noted that the choice of three carriers and three time slots is for illustrative purposes and is not intended as a limitation on the number of carriers or time slots.

To calculate the number of information bits in one UWB symbol formed in accordance with the enhanced spectral keying of the present invention and wherein for illustrative purposes there are three frequency carriers and three modulation symbol times, the combinations with only one frequency carrier turned on at a time are determined, the combinations with a maximum of two frequency carriers turned on at a time are determined, and the combinations with a maximum of three frequency carriers turned on at a time are determined. The number of combinations are added to produce a “total”, and a value for log₂(total) is determined.

The combinations described above are enumerated below. The combinations with only one frequency carrier turned on at a time are: {1,2,3}, {1,3,2,}, {2,1,3}, {2,3,1}, {3,1,2}, and {3,2,1} for a total of six. The combinations with a maximum of two frequency carriers turned on at a time are:

{(1,2),3,0}, {(1,2),0,3}, {3,(1,2),0}, {0,(1,2),3}, {3,0,(1,2)}, {0,3,(1,2)}

{(1,3),2,0}, {(1,3),0,2}, {2,(1,3),0}, {0,(1,3),2}, {2,0,(1,3)}, {0,2,(1,3)}

{(2,3),1,0}, {(2,3),0,1}, {1,(2,3),0}, {0,(2,3),1}, {1,0,(2,3)}, and {0,1,(2,3)}

for a total of eighteen. The combinations with a maximum of three frequency carriers turned on at a time are: {(1,2,3),0,0}, {0,(1,2,3),0}, and {0,0,(1,2,3)} for a total of three. Adding 6, 18, and 3 gives the total number of combinations as 27. So the total number of additional information bits is log₂(27)=4.75, as compared to 2.58 with the previous spectral keying scheme.

It will be appreciated by those of ordinary skill in this field, and having the benefit of this disclosure, that the amount of data encoded in a UWB symbol in accordance with the present invention significantly increases as the number of frequency carriers is increased.

In one embodiment of the present invention, as shown in FIG. 3, a method of transmitting symbols with a transmitter having a set of n frequency carriers, wherein each symbol has n modulation symbol times, includes providing 302 data to be transmitted; determining 304, based at least in part on the data that is provided, which of the n frequency carriers, if any, are to be turned on during each of the n modulation symbol times, each modulation symbol time being of a predetermined amount of time; and turning on 306 each of the frequency carriers as determined above, during each of the modulation symbol times; wherein each frequency carrier is turned on for a period of time substantially the same as that of a modulation symbol time; and wherein each frequency carrier is turned on only once during the transmission of the symbol. The data is encoded into a symbol to be transmitted by assigning the various frequency carriers to be turned on during particular portions of the symbol, these portions being referred to herein as modulation symbol times. The method of transmitting symbols in accordance with the present invention may be referred to as enhanced spectral keying for UWB symbols.

In accordance with the present invention, a symbol, may have one or more modulation symbol times in which no frequency carrier is turned on. Similarly, in accordance with the present invention, a symbol may have at least one modulation symbol time in which at least two frequency carriers are turned on. In typical embodiments, the transmitted symbols occupy a frequency bandwidth greater than 500 MHz. In some embodiments of the present invention the transmitted symbols occupy a frequency bandwidth greater than 2 GHz. Typical embodiments include waiting for a period of time, referred to as a guard time, after the transmission of one symbol until the beginning of the transmission of a next symbol.

One embodiment of present invention is a method of generating information symbols including: (a) turning on, for an i^{th} predetermined length of time, during an i^{th} time period, xᵢ frequency carriers, where 0≦xᵢ≦n, and 1≦i≦n; (b) determining whether n−Σxᵢ=0; and (c) if the determination of (b) is negative, repeating (a) through (b); wherein xᵢ represents an integer number of frequency carriers. In such an embodiment, each i^{th} time period may also be referred to as a modulation symbol time, and the information symbol is made up of n modulation symbol times. In this embodiment of the present invention, the number of frequency carriers and the number of modulation symbol times are the same. In alternative embodiments, the number of frequency carriers may be represented by an integer n, and the number of modulation symbol time periods may be represented by an integer m, wherein n and m are different. In such an embodiment, rather than determining whether n−Σxᵢ=0, one would determine whether the number of modulation symbol time periods has reached the total number m of time periods per USB symbol.

In typical embodiments of the present invention, the frequency carriers are turned on at the beginning of a modulation symbol time and turned off at the end of that modulation symbol time. However, in alternative embodiments of the present invention, identical temporal alignment of frequency carrier operation and modulation symbol time boundaries may not be required, but rather some accommodation is provided for recognizing a symbol wherein there is some misalignment between the time of frequency carrier operation and the modulation symbol time boundaries.

Various embodiments of the present invention include methods and apparatus for providing more information in a UWB symbol, than is possible with pulse position modulation UWB, and further provides more information in a UWB symbol than is possible with previously proposed spectral keying schemes. By taking advantage of combinations of frequency carriers, the number of UWB information bits that can be transmitted within a given time can be increased without requiring additional frequency resources.

An advantage of some embodiments of the present invention, is that higher data rates can be achieved in a communication system in accordance with the present invention.

An advantage of some embodiments of the present invention, is that these scale exponentially as the number of available carriers increases.

It is to be understood that the present invention is not limited to the embodiments described above, but encompasses any and all embodiments within the scope of the subjoined Claims.

1. A method of generating information symbols, comprising: (a) turning on, for an i^{th} predetermined length of time, during an i^{th} time period, xᵢ frequency carriers, where 0≦xᵢ≦n, and 1≦i≦n; (b) determining whether n−Σxᵢ=0; and (c) if the determination of (b) is negative, repeating (a) through (b); wherein xᵢ represents an integer number of frequency carriers, and n represents a total number of available frequency carriers.

2. The method of claim 1, further comprising: (d) if the determination of (b) is affirmative, waiting for a period of time.

3. The method of claim 2, further comprising: subsequent to waiting for the period of time, repeating (a) through (c).

4. The method of claim 3, wherein the period of time is a predetermined guard band that is disposed between information symbols.

5. The method of claim 4, wherein the information symbols occupy a frequency bandwidth greater than 500 MHz.

6. A method of transmitting symbols, each symbol having n modulation symbol times, with a transmitter having a set of n frequency carriers, comprising: providing data to be transmitted; and determining based at least in part on the provided data, which frequency carriers, if any, of the set of n frequency carriers, are to be turned on during each of the n modulation symbol times, each modulation symbol time being of a predetermined amount of time; and turning on each of the frequency carriers as determined in (b) during each of the modulation symbol times; wherein each frequency carrier must be turned on for a period of time not greater than the modulation symbol time; and wherein each frequency carrier is turned on only once during the transmission of the symbol.

7. The method of claim 6, wherein at least one modulation symbol time has no frequency carriers turned on.

8. The method of claim 7, wherein at least one modulation symbol time has at least two frequency carriers turned on.

9. The method of claim 8, wherein a BPSK modulation is used.

10. The method of claim 6, wherein if n frequency carriers are turned on in one modulation symbol time, then no frequency carriers are turned on in the other n−1 modulation symbol times.

11. The method of claim 6, wherein the transmitted symbols occupy a frequency bandwidth greater than 500 MHz.

12. The method of claim 6, wherein the transmitted symbols occupy a frequency bandwidth greater than 2 GHz.

13. The method of claim 11, wherein the n frequency carriers transmit signals in n contiguous frequency bands, and n is an integer.

14. The method of claim 11, wherein the n frequency carriers transmit signals in n non-contiguous frequency bands, and n is an integer.

15. A method of transmitting ultra wideband symbols, comprising: (a) turning on, for an i^{th} predetermined length of time, during an i^{th} time period, xᵢ frequency carriers, where 0≦xᵢ≦n, and 1≦i≦m; (b) determining whether m time periods have expired; and (c) if the determination of (b) is negative, repeating (a) through (b); wherein x₁ represents an integer number of frequency carriers, n represents a total number of available frequency carriers, and m represents a total number of time periods contained within each of the ultra wideband symbols.
